(19) United States
(12) Patent Application Publication
(10) Pub. No.: US 2004/0249865 A1
(43) Pub. Date: Dec. 9, 2004

(54) System and method for scheduling and naming for database backup

(76) Inventors: Chung-I Lee, Tu-chen (TW); Yekoo Wong, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/863,173

(22) Filed: Jun. 7, 2004

(30) Foreign Application Priority Data
Jun. 6, 2003 (TW) 92115455

(51) Int. Cl. G06F 12/00

(52) U.S. Cl. 707/200

(57) ABSTRACT

A system for scheduling and naming for database backup includes a schedule file (123), and a schedule and name module (121). The schedule file records a plurality of units of schedule data, each unit including a database name, a scheduled activity and a scheduled date. The scheduled activity is a backup activity or a recovery activity. The schedule and name module is for creating the schedule file, and naming the backup object based on the schedule file. A related method includes: (a) creating a schedule file for recording one or more database names, scheduled activities and scheduled dates; (b) commencing a scheduled activity according to the schedule file; (c) determining whether the scheduled activity is a backup activity or a recovery activity; and (d) create a backup object if the scheduled activity is a backup activity, and automatically naming the backup object according to a scheduled date.

### BACKGROUND OF THE INVENTION

1. Field of the Invention

The present invention relates to a system and method for supporting database backup of a database management system (DBMS), and particularly to a system and method for helping system administrators to create a schedule for database backup, and for automatically determining a file/folder name of a backup file/folder according to a scheduled date.

2. Description of Related Art

In general, a database management system (DBMS) of an enterprise provides scheduling functions for administrators to prearrange a schedule for automatically executing database backup and recovery. This helps prevent data generated during performance of daily tasks from being lost. There are typically at least two databases, comprising an active database and a backup database. The active database is for storing enterprise data, and the backup database is for helping backup of the enterprise data. As used herein, the term “backup” means compressing a plurality of data files in the active database to become a backup object for storing to the backup database. The backup object may be a compressed file (e.g. .dpm), or a folder stored a plurality of compressed files. As used herein, the term “recovery” means essentially the reverse of the above-described “backup.” That is, decompressing the compressed file(s) to become the original data files, and storing the original data files back into the active database. The DBMS can also record relevant information (e.g. date of backup/recovery, active database name, etc.) in a log file after backup and recovery have been finished. For administrators to intuitively manage numerous backup objects, one solution is to determine the file/folder name of the backup object according to relevant information. For example, the date of backup is appended onto the file name of each backup object to show the temporal relationship between numerous backup objects. Usually, an administrator manually enters the file/folder name. The DBMS does not automatically determine file/folder names.

The art of supporting backup and recovery is disclosed in U.S. Pat. No. 6,324,548 issued on Nov. 27, 2001 and entitled “Database Backup and Recovery Using Separate History Files for Database Backup and Audit Backup.” This patent discloses a system for using separate history files to record backup dates, for helping administrators to manage backup files in a backup database. Administrators can audit the backup with backup history by referencing separate history files. However, the system does not provide a more intuitive way for helping administrators to manage backup files in a backup database. Accordingly, what is needed is a system and method that provides an intuitive way for allowing administrators to manage backup files/folders in a backup database.

### SUMMARY OF THE INVENTION

An object of the present invention is to provide a system and method for helping an administrator to prearrange a schedule for database backup and recovery.

Another objective of the present invention is to provide a system and method for automatically determining a backup file/folder name according to relevant information on database backup.

To accomplish the above objectives, a system for scheduling and naming for database backup in accordance with a preferred embodiment of the present invention comprises a schedule file, a first management module, and a schedule and name module. The schedule file records units of schedule data; each unit of schedule data comprises a database names, a scheduled activities, and a scheduled dates. The scheduled activity may be either a backup activity or a recovery activity. The schedule file is for automatically executing the scheduled activity at scheduled date on the database matching the database name. The first management module is for automatically backup a plurality of data files from a first database to a second database according to the schedule file. The schedule and name module is for helping administrator to create the schedule file, and automatically determining the file/folder name of backup object according to the scheduled date.

Further, the present invention provides a preferred method for scheduling and naming for database backup, comprising (a) creating a schedule file for recording one or more database names, scheduled activities and scheduled dates; (b) commencing a scheduled activity according to the schedule file; (c) determining whether the scheduled activity is a backup activity or a recovery activity; (d) create a backup object if the scheduled activity is a backup activity, and automatically naming the backup object according to a scheduled date; and (e) logging the database name, the scheduled activity, and the scheduled date in a log file.

### BRIEF DESCRIPTION OF THE DRAWINGS

FIG. 1 is a schematic diagram of hardware infrastructure of a system for scheduling and naming for database backup in accordance with the present invention;

FIG. 2 is a block diagram of main function units of the system of FIG. 1;

FIG. 3 is a schematic diagram showing the naming rule used in the present invention;

FIG. 4 is a block diagram a schedule and name module of FIG. 2;

FIG. 5 is a flowchart of a method for scheduling and naming for database backup in accordance with the present invention.

### DETAILED DESCRIPTION OF THE INVENTION

Reference will now be made to the drawing figures to describe the present invention in detail.

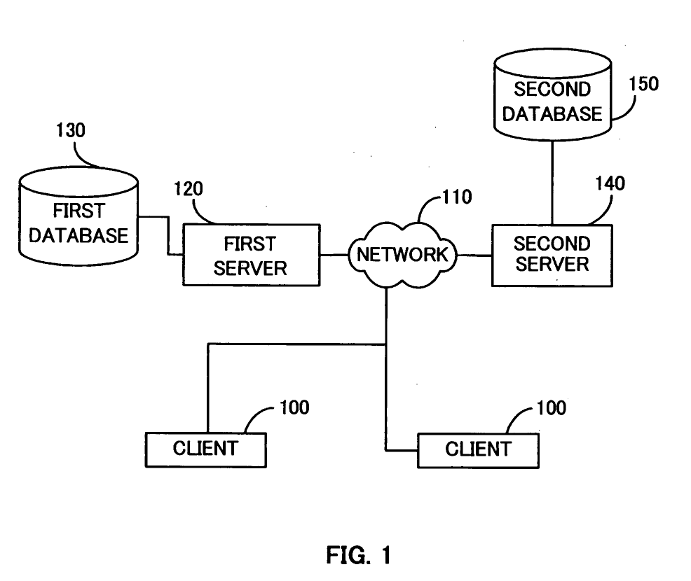

FIG. 1 is a schematic diagram of hardware infrastructure of a system for scheduling and naming for database backup in accordance with the present invention. The scheduling is for enterprise administrators to help an enterprise DBMS determine which of active databases should perform what activities and when. The naming is for helping administrators intuitively manage numerous backup objects. That is, the DBMS automatically determines the file/folder name according to relevant information contained in the file/folder.

The hardware infrastructure comprises a network 110 interconnecting a first server 120, a second server 140, and a plurality of clients 100. The first server 120 connects to a first database 130, and the second server 140 connects to a second database 150.

The first server 120 is used for electronically visiting the first database 130, making a backup copy of the first database 130, and recovering the backup copy of the first database 130. The first database 130 is an active database of an enterprise for storing relevant data used in daily tasks. The second server 140 is used for visiting the second database 150, and copying the backup copy of the first database 130 to the second database 150. The second database 150 is a backup database of the enterprise, for storing a backup copy of relevant data used in daily tasks. The plurality of clients 100 is provided for administrators to visit and set schedules for backup and recovery.

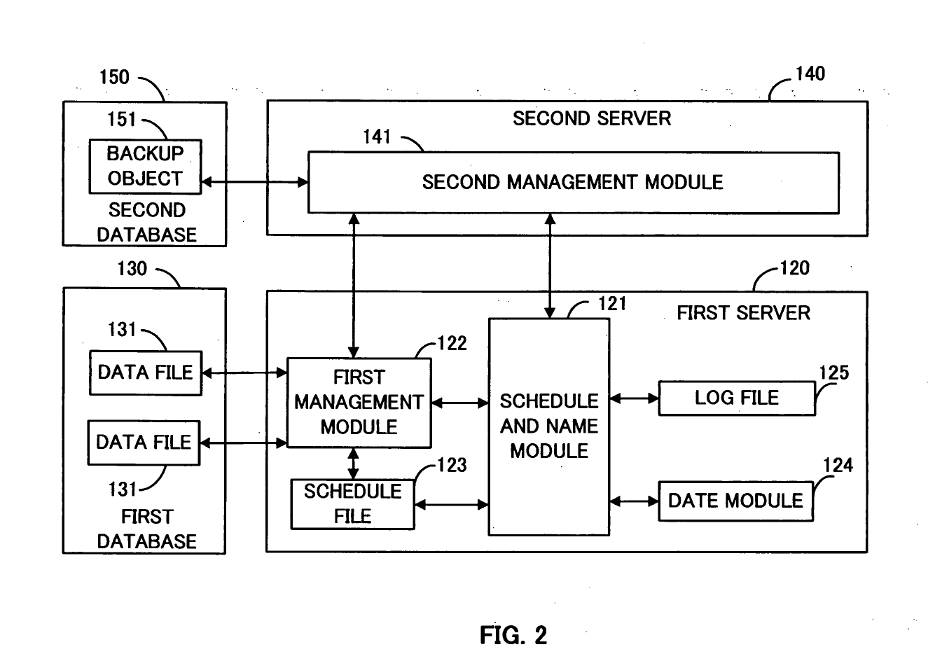

FIG. 2 is a block diagram of main function units of the system for scheduling and naming for database backup. The first server 120 comprises a schedule and name module 121, a first management module 122, a schedule file 123, a date module 124, and a log file 125. The first database 130 comprises a plurality of data files 131 that contain relevant data used in daily tasks. The second server 140 comprises a second management module 141. The second database 150 comprises a backup object 151, which itself comprises compressed data of the data files 131.

Additionally, the DBMS comprises the first management module 122 and the second management module 141 for duplicating the data files 131 to the backup object 151, and recovering the backup object 151 back to the data files 131. The schedule and name module 121 is used for creating the schedule file 123 and naming files and folders. The schedule file 123 records a plurality of units of schedule data. Each unit of schedule data comprises a database name, a scheduled activity, and a scheduled date. The scheduled activity may be either a backup activity or a recovery activity. The schedule file 123 is the basis for the first management module 122 to automatically backup the data files 131 of the first database 130, or recover the backup object 151 back to the data files 131. The schedule and name module 121 can also record relevant information on backup or recovery in the log file 125. The date module 124 provides date information for the schedule and name module 121, in order to automatically trigger the first database 130 to backup or recover at the right time.

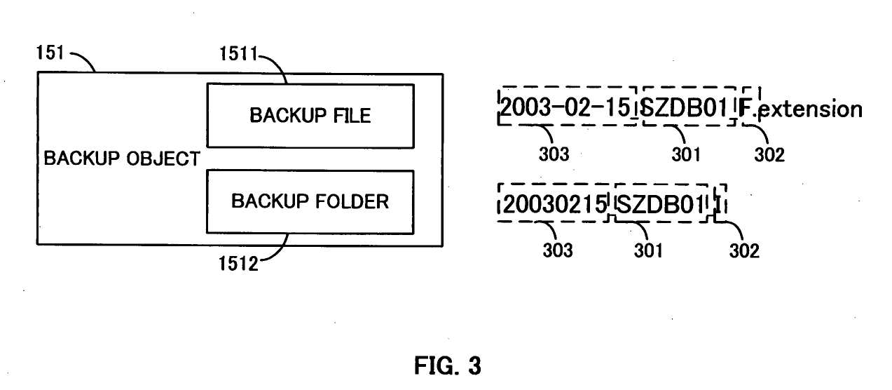

FIG. 3 is a schematic diagram showing a naming rule used in the present invention. It should be noted that if an administrator uses a different backup strategy to the preferred embodiment described herein, the backup object will be different to the preferred backup object 151 described herein. The backup object 151 comprises a backup file 1511 and a backup folder 1512. A plurality of data files 131 can be compressed into one backup file 1511. Alternatively, each data file 131 can be compressed, and the compressed files can all be stored in the backup folder 1512.

Additionally, the schedule and name module 121 determines the name of the backup object 151 according to a database name 301, a scheduled activity 302, and a scheduled date 303. The scheduled activity 302 and the scheduled date 303 are recorded in the schedule file 123. The database name 301 is the name of the first database 130. The scheduled activity 302 may be either a backup activity or a recovery activity. The backup activity comprises a full mode and an independent mode. Under the full mode, all data files 131 in the first database 130 are backed up to the second database 150. Under the independent mode, only some of the data files 131 in the first database 130 are backed up to the second database 150. That is, only data files 131 that are different from the data files 131 of the last backup of the first database 130 are backed up. The scheduled date 303 is the date for backup.

There are several naming rules for naming the backup file 1511 according to the scheduled date 303:

rule 1: [scheduled date 303].extension (the extension can be .dmp).

rule 2: [scheduled date 303]_[database name 301].extension (the extension can be .dmp).

rule 3: [scheduled date 303]_[database name 301]_[scheduled activity 302] .extension (the extension can be .dmp).

There are also several naming rules for naming the backup folder 1512 according to the scheduled date 303:

rule 4: [scheduled date 303].

rule 5: [scheduled date 303]_[database name 301].

rule 6: [scheduled date 303]_[database name 301]_[scheduled activity 302].

In the above rules 1˜6, the scheduled date 303 is expressed numerically. The database name 301 is expressed alphanumerically, and is preceded and succeeded by the symbol “_”. Even though the scheduled activity 302 may be either a backup activity or a recovery activity, only the backup activity is expressed in the above naming rules. The full mode of backup activity is expressed as “F”. The independent mode of backup activity is expressed as “I”.

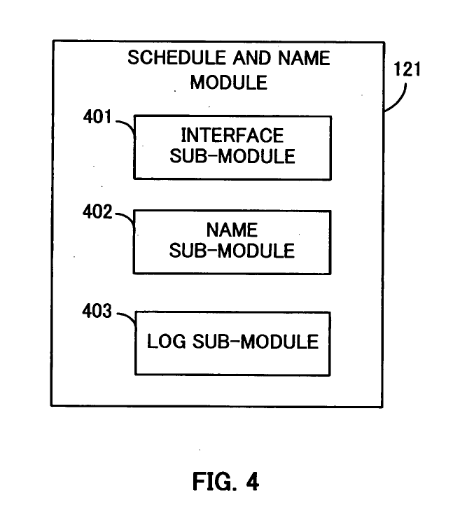

FIG. 4 is a schematic diagram of sub-modules of the schedule and name module 121. The schedule and name module 121 comprises an interface sub-module 401, a name sub-module 402, and a log sub-module 403. The interface sub-module 401 provides a schedule interface on any client 100 for an administrator to use to create the schedule file 123. The name sub-module 402 is for naming the backup object 151 according to the name rules described above. At the end of a backup, the log sub-module 403 is used for recording the database name 301, scheduled activity 302 and scheduled date 303 in the log file 125.

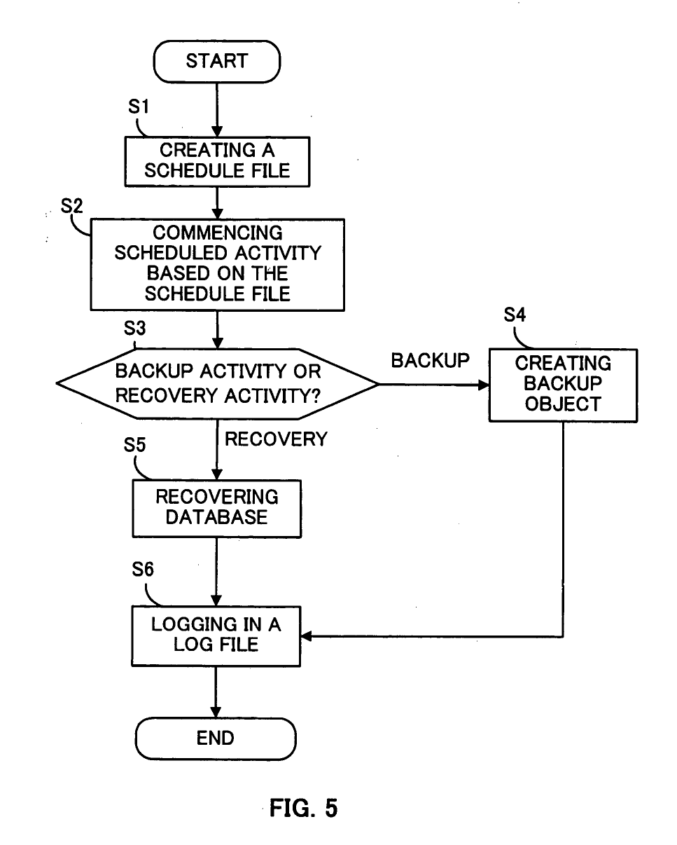

FIG. 5 is a flowchart of a preferred method for scheduling and naming for database backup in accordance with the present invention. The method is implemented using the above-described system for scheduling and naming for database backup. In step S1, a schedule file 123 is created. The schedule file 123 is for recording a database name, scheduled activity and scheduled date in order to automatically backup and recover the first database 103. In step S2, based on the schedule file 123, the recorded scheduled activity is commenced on the recorded scheduled date. In step S3, the system for scheduling and naming for database backup determines whether the scheduled activity is a backup activity or a recovery activity. If the scheduled activity is a backup activity, the DBMS creates a backup object 151, and the system for scheduling and naming for database backup automatically determines the file or folder name of the backup object 151. The procedure then goes to step S6 described below. If the scheduled activity is a recovery activity, in step S5, the first database 130 is recovered. The procedure then goes to step S6. In step S6, the database name, scheduled activity and scheduled date are logged in the log file 125.

The invention has been described in terms of certain preferred and alternative embodiments which are representative of only some of the various ways in which the basic concepts of the invention may be implemented. Implementation of the inventive concepts which may occur to those of ordinary skill in the art are within the scope of the invention and equivalents as defined by the accompanying claims.

What is claimed is:

1. A system for scheduling and naming for database backup, comprising:
a schedule file for recording database names, scheduled activities and scheduled dates;
a first management module for automatically backup a plurality of data files from a first database to a second database according to the schedule file; and
a schedule and name module for creating the schedule file, and naming a backup object based on a scheduled date.

2. The system for scheduling and naming for database backup as claimed in claim 1, wherein the scheduled activity is a backup activity, the backup activity may be full mode or independent mode, full mode is for backup of all data files, and independent mode is for backup of only some data files.

3. The system for scheduling and naming for database backup as claimed in claim 1, wherein the scheduled date is the date for backup of the first database.

4. The system for scheduling and naming for database backup as claimed in claim 1, wherein the naming of the backup object is further based on the first database's name.

5. The system for scheduling and naming for database backup as claimed in claim 1, wherein the naming of the backup object is further based on a scheduled activity.

6. The system for scheduling and naming for database backup as claimed in claim 5, wherein the scheduled activity is a backup activity comprising full mode and independent mode.

7. The system for scheduling and naming for database backup as claimed in claim 1, wherein the schedule and name module comprises:
an interface sub-module for providing an interface for an administrator to create the schedule file; and
a name sub-module for facilitating naming of the backup object according to the scheduled date.

8. The system for scheduling and naming for database backup as claimed in claim 7, wherein the schedule and name module further comprises a log sub-module for recording the scheduled date, a scheduled activity and the first database’s name in a log file.

9. A method for scheduling and naming for database backup, comprising the steps of:
creating a schedule file for recording one or more database names, scheduled activities and scheduled dates;
commencing a scheduled activity according to the schedule file;
determining whether the scheduled activity is a backup activity or a recovery activity;
creating a backup object if the scheduled activity is a backup activity, and
automatically naming the backup object according to a scheduled date; and
logging a database name, the scheduled activity and the scheduled date in a log file.

10. The method for scheduling and naming for database backup as claimed in claim 9, wherein the backup activity may be full mode or independent mode.

11. The method for scheduling and naming for database backup as claimed in claim 9, wherein the scheduled date is the date for backup of the database.

12. The system for scheduling and naming for database backup as claimed in claim 9, wherein the naming of the backup object is based on the database's name.

13. The system for scheduling and naming for database backup as claimed in claim 9, wherein the naming of the backup object is based on the scheduled activity.

14. The system for scheduling and naming for database backup as claimed in claim 13, wherein the scheduled activity is a backup activity comprising full mode and independent mode.

15. The system for scheduling and naming for database backup as claimed in claim 9, further comprising the step of recovering the database if the scheduled activity is a recovery activity.

16. A system for scheduling and naming for database backup, comprising:
means for creating a schedule file for recording one or more database names, scheduled activities and scheduled dates;
means for commencing a scheduled activity according to the schedule file;
means for determining whether the scheduled activity is a backup activity or a recovery activity;
means for creating a backup object if the scheduled activity is a backup activity, and automatically naming the backup object according to a scheduled date; and
means for logging a database name, the scheduled activity and the scheduled date in a log file.
